(19) United States
(12) Patent Application Publication
(10) Pub. No.: US 2010/0018179 A1
(43) Pub. Date: Jan. 28, 2010

(54) PLANAR, GENERALLY "U" OR "V" SHAPED CHAIN LINK

(76) Inventors: Cheo CHIA, Los Angeles, CA (US); Meang Chia, Los Angeles, CA (US); Huy Chia, Los Angeles, CA (US)

Correspondence Address: LADAS & PARRY, 5670 WILSHIRE BOULEVARD, SUITE 2100, LOS ANGELES, CA, 90036-5679, US

(21) Appl. No.: 12/474,209

(22) Filed: May 28, 2009

Related U.S. Application Data
(60) Provisional application No. 61/130,374, filed on May 29, 2008.
(60) Provisional application No. 61/137,750, filed on Aug. 1, 2008.

(51) Int. Cl. B21L 3/00; F16G 13/00

(52) U.S. Cl. 59/35.1; 59/82

(57) ABSTRACT

In an embodiment, a planar, generally “U” or “V” shaped chain link is disclosed. The chain link may include or comprise a member with at least one aperture formed therein, wherein the at least one aperture is sized to receive an identical member there through.

### CROSS REFERENCE TO RELATED APPLICATIONS

This application claims the benefit of U.S. Provisional Application No. 61/130,374, filed on May 29, 2008, and U.S. Provisional Application No. 61/137,750, filed on Aug. 1, 2008, which are incorporated herein by reference in their entirety.

### TECHNICAL FIELD

The present application relates to the field of chain links.

### BACKGROUND

A chain may include a series of components that are linked, connected, or associated together. Such a chain may be configured to be used for various purposes, such as to provide physical, mechanical or structural support or restraint, or such as to transfer an amount of mechanical power. Additionally, a chain may be designed as a decorative piece that may be used or worn as an ornament or insignia, such as a necklace or bracelet.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In an embodiment, a planar, generally “U” or “V” shaped chain link is disclosed. The chain link may include or comprise a member with at least one aperture formed therein, wherein the at least one aperture is sized to receive an identical member there through.

Additionally, in an embodiment, a chain is disclosed. The chain may include or comprise a first chain link that is planar and generally “U” or “V” shaped with an aperture formed therein, and a second chain link positioned through such aperture.

Moreover, in an embodiment, a method of chain manufacture is disclosed. The method may include or comprise selecting a first chain link that is planar and generally “U” or “V” shaped with an aperture formed therein, selecting a second chain link sized to be displaced through the aperture, and displacing the second chain link through the aperture to form a chain.

### DESCRIPTION OF THE DRAWINGS

The accompanying drawings, which are incorporated in and form a part of this specification, illustrate embodiments of the present technology, and, together with the Detailed Description, serve to explain principles discussed below.

FIG. 1A is a diagram of a first exemplary configuration of an exemplary chain link in accordance with an embodiment.

FIG. 1B is a diagram of a second exemplary configuration of an exemplary chain link in accordance with an embodiment.

FIG. 1C is a diagram of a third exemplary configuration of an exemplary chain link in accordance with an embodiment.

FIG. 1D is a diagram of a fourth exemplary configuration of an exemplary chain link in accordance with an embodiment.

FIG. 1E is a diagram of a fifth exemplary configuration of an exemplary chain link in accordance with an embodiment.

FIG. 1F is a diagram of a sixth exemplary configuration of an exemplary chain link in accordance with an embodiment.

FIG. 1G is a diagram of a seventh exemplary configuration of an exemplary chain link in accordance with an embodiment.

FIG. 2 is a diagram of a first exemplary linking configuration in accordance with an embodiment.

FIGS. 3A and 3B are different views of a second exemplary linking configuration in accordance with an embodiment.

FIG. 4 is a diagram of an exemplary chain in accordance with an embodiment.

FIGS. 5A-5E are different views of a plurality of linked elements of an exemplary chain in accordance with an embodiment.

FIGS. 6A-6B are different views of a coupling member of an exemplary chain in accordance with an embodiment.

FIG. 7 is a flowchart of an exemplary method of chain manufacture in accordance with an embodiment.

The drawings referred to in this description are not to be understood as being drawn to scale except if specifically noted. Additionally, it is noted that these drawings are exemplary in nature, and that the present technology is not limited to the exemplary embodiments presented in such drawings.

### DETAILED DESCRIPTION

Reference will now be made in detail to embodiments of the present technology, examples of which are illustrated in the accompanying drawings. While the present technology will be described in conjunction with various embodiments, these embodiments are not intended to limit the present technology. Rather, the present technology is to be understood as encompassing obvious alternatives, modifications and equivalents of the various embodiments discussed herein, such as those embodiments defined by the appended claims. Indeed, various exemplary embodiments, or aspects thereof, may be combined pursuant to the present technology.

Furthermore, in the following Detailed Description numerous specific details are set forth in order to provide a thorough understanding of the present technology. However, the present technology may be practiced without these specific details. In other instances, well-known methods, procedures, components and instrumentation have not been described in detail so as to not unnecessarily obscure aspects of the exemplary embodiments presented herein.

It is noted that, for purposes of the following discussion, the term “plurality” refers to two or more. Additionally, the terms “first”, “second”, “third” and fourth are not to be construed as imparting a numerical order or a degree of importance. Furthermore, the term “diameter” refers to a width, wherein such width may, but need not, be defined by a length through a center or central portion of a cross section of a defined area.

### Overview

Various methods may be implemented to produce chain-style articles of jewelry, such as necklaces and bracelets. For example, a “rope chain” may be constructed by linking a number of links together in a repetitive and intricate manner and soldering together each successive group of two links. Because adjacent pairs of links are not soldered or otherwise connected together, the result is a chain that is flexible, three dimensional in depth, light-reflective and pleasing to the eye.

However, the manufacturing of quality rope chain jewelry can be a painstakingly, labor-intensive task, and is best performed when carried out by hand. Indeed, although rope chain linking elements may be interconnected with customized machinery, such an automated manufacturing process can result in a chain wherein the individual links are loosely arranged, and wherein such chain is less pleasing to the eye than similar chains that are hand-made.

Various embodiments of the present technology pertain to a novel link component, a method of making jewelry using the new link component, and a new type of chain made from the new link component. The chain produced by the link component, in accordance with an embodiment of the present technology, requires less labor and time to make than many previous chain arrangements. However, the resulting chain is three-dimensional, highly reflective, and as pleasing to the eye as, for example, the aforementioned rope chain.

With reference now to an embodiment of the present technology, the basic link component is an essentially “U” or “V” shaped disk which includes a connecting stem with appendages at each end of the connecting stem. One or more eyelets are formed in the link component, such as in the aforementioned appendages, wherein such eyelets are sized such that another chain link of similar or identical size may be inserted there through.

In one embodiment, multiple chain links having respective geometries such as previously described are linked together to form a chain. In the case where a link component has at least two apertures formed therein, wherein a different chain link is positioned through each of these apertures, it is noted that the resulting chain will appear to be relatively dense even though the chain is constructed from a relatively low number of chain links that are also relatively thin. In this manner, manufacturing costs and the content of precious materials, such as gold, may be minimized while aesthetic appeal is maintained.

Thus, an embodiment of the present technology provides that the use of relatively thin link components may be used to create a chain that does not appear hollow, while simultaneously enabling one to realize a significant savings in manufacturing materials (e.g., gold). For example, an 18 inch rope chain may include 22 grams of gold, whereas an 18 inch chain manufactured in accordance with an embodiment disclosed herein may include 5 grams of gold, which can significantly decrease costs associated with chain manufacture.

At the same time, although less material is implemented, various configurations discussed herein enable the resulting chain to have a similar tensile strength as compared to a rope chain of similar length and dimensions. Moreover, in accordance with an embodiment, although a number of end links (e.g., annular links) may be soldered together, the other individual link components that form the chain are not soldered together, which both simplifies and speeds the manufacturing process. Furthermore, although the resulting chain is relatively hollow, it is noted that the surfaces of the links may be configured to be relatively light reflective such that the resulting chain is at least as “sparkly” as a rope chain of similar length and width.

### Exemplary Chain Link Configurations

Various exemplary configurations of a chain link in accordance with the present technology will now be described. However, the present technology is not limited to these exemplary configurations. Indeed, other configurations of a chain link may also be implemented pursuant to the present technology.

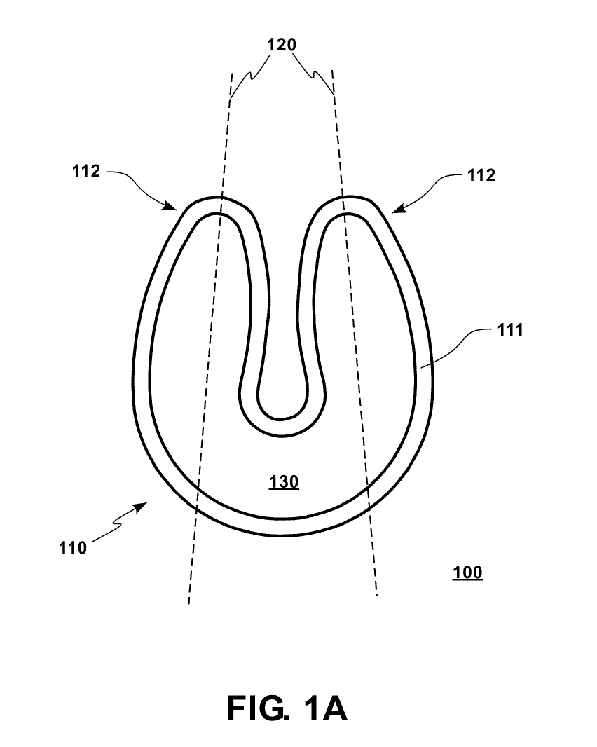

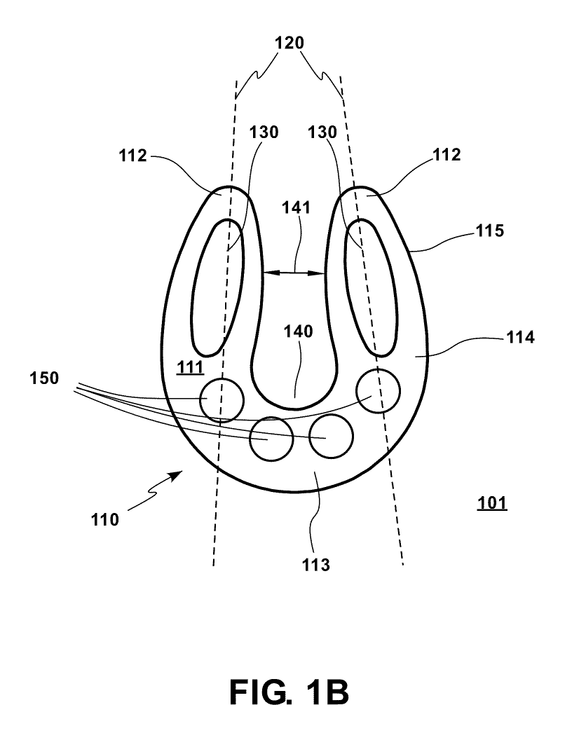

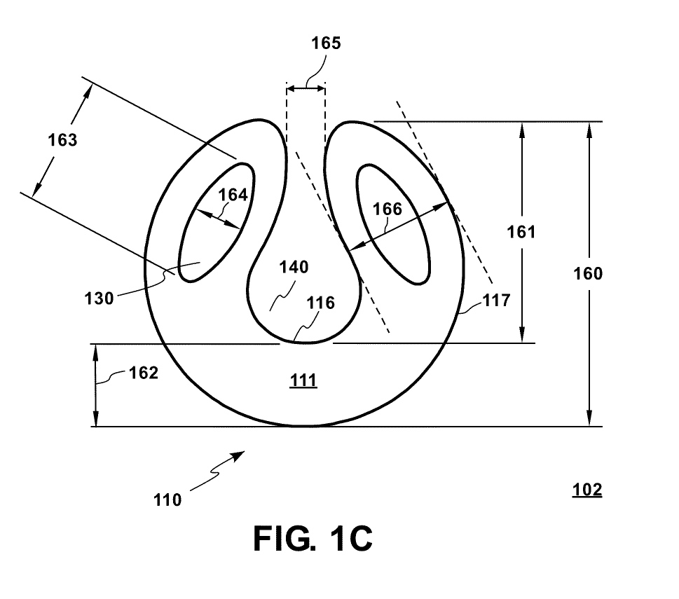

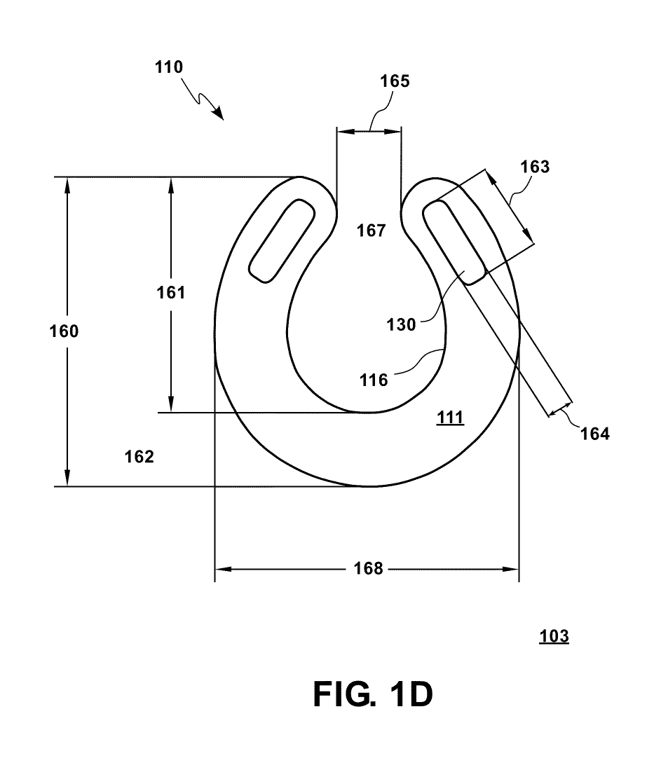

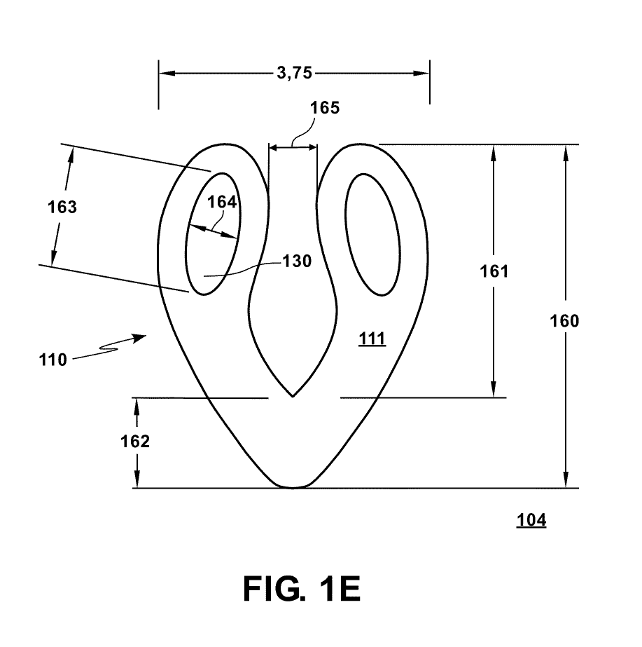

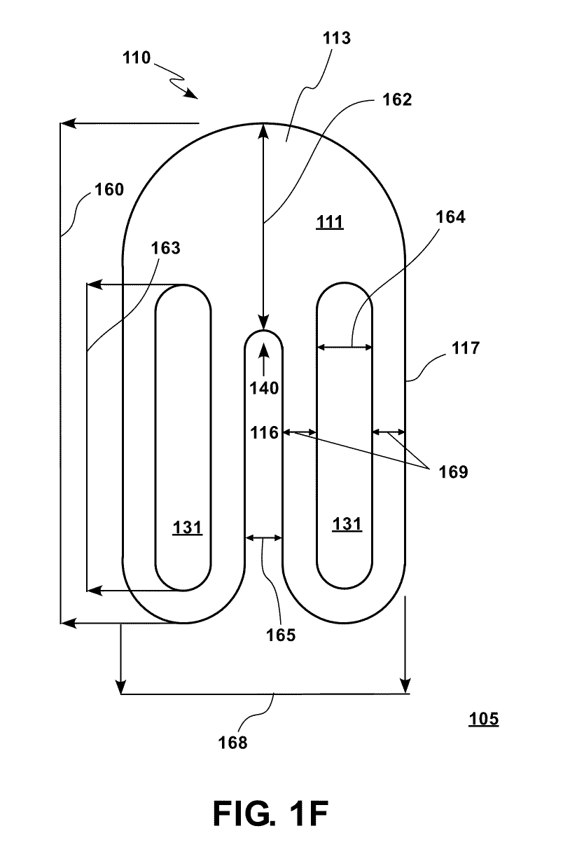

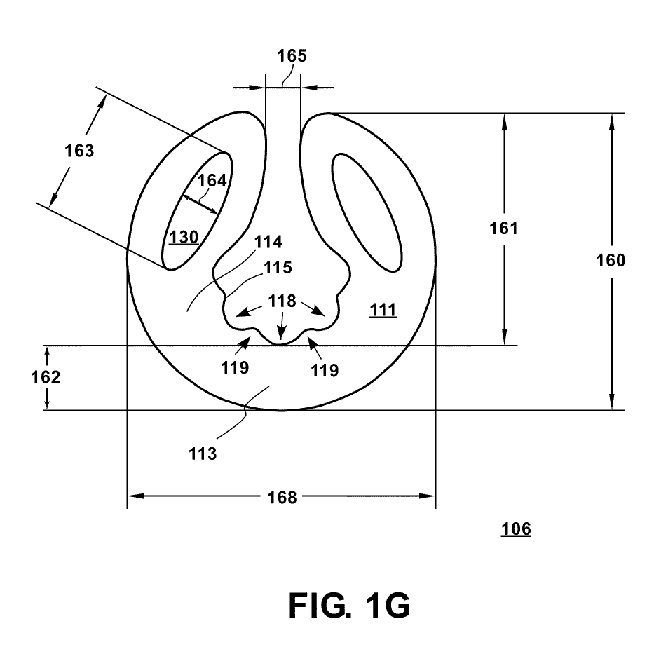

With reference now to FIG. 1A, a first exemplary configuration 100 of an exemplary chain link 110 in accordance with an embodiment disclosed herein is shown. Chain link 110 is shown as being a generally “U” shaped chain link. However, it is noted that chain link 110 may also be “V” or “C” shaped, such as further discussed herein. Indeed, other geometries for a chain link may also be adapted in accordance with the present technology.

In one embodiment, chain link 110 has a planar geometry. Consider the example where chain link 110 is substantially flat such that a physical body of member 111 is substantially positioned within a same geometric plane. The foregoing notwithstanding, chain link 110 may also be non-planar in accordance with the present technology. Indeed, the present technology is not limited to a chain link of any particular size or shape.

With reference still to FIG. 1A, chain link 110 includes a member 111 having generally opposed ends 112, or appendages, extending along different axes of protraction 120. An aperture 130 is formed in member 111, wherein aperture 130 is large enough so that another chain link may be inserted through aperture 130 such that chain link 110 may be linked to another chain link so as to form a chain. Consider the example where aperture 130 is sized to receive an identical, or substantially similar, member there through such that a chain link having a geometry identical, or substantially similar, to chain link 110 may be displaced through aperture 130. It is noted, however, that the present technology is not limited to an aperture of any particular size or shape.

The foregoing notwithstanding, an embodiment provides that the physical dimensions, color, ability to reflect light, and other attributes of the link components of a chain, such as chain link 110, may be selected so as to configure the chain to have a particular appearance. These concepts are explored in further detail herein.

With reference now to FIG. 1B, a second exemplary configuration 101 of chain link 110 in accordance with an embodiment disclosed herein is shown. Chain link 110 is shown as having a geometry substantially similar to that shown in first exemplary configuration 100. In particular, chain link 110 includes member 111, which has generally opposed ends 112, or appendages, extending along different axes of protraction 120 such that an inlet 140 is formed between generally opposed ends 112, and such that generally opposed ends 112 are separated by a gap 141. Generally opposed ends 112 are coupled together by a connecting stem or base member 113, and each end from among generally opposed ends 112 has an aperture 130 formed therein.

With reference still to the illustrated embodiment, member 111 has a first major surface 114 and a second major surface (not shown) located generally opposite to first major surface 114 on a reverse side of member 111. Member 111 also has a side or peripheral surface 115 that corresponds to or defines an outer edge of member 111, wherein peripheral surface 115 is located adjacent to both first major surface 114 and the aforementioned second major surface.

In an embodiment, one or more of the aforementioned surfaces of member 111 are light reflective such that member 111 may be utilized to reflect an amount of light. Indeed, in one embodiment, one or more of first major surface 114 and the aforementioned second major surface is a light reflective surface having a number of protrusions formed therein, such as further discussed and illustrated herein. Consider the example where first major surface 114 is a reflective surface, such as where member 111 is made of, or plated with, gold, silver, or another reflective material. A number of protrusions are formed in first major surface 114 such that first major surface 114 is not completely flat, even if member 111 has a planar geometry. In this manner, first major surface 114 may be configured to reflect light in a greater number of directions as compared to a flat reflective surface.

With reference still to the previous embodiment, an example provides that the protrusions are “V” shaped facets. However, the present technology is not limited to facets that are “V” shaped. Indeed, protrusions or facets of various different geometries may be implemented pursuant to the present technology.

With reference still to FIG. 1B, member 111 has generally opposed ends 112, or appendages, extending along different axes of protraction 120, as explained above. Additionally, each of generally opposed ends 112 has an aperture 130, or eyelet, formed therein such that multiple apertures are formed in member 111. However, although member 111 is shown as having two different apertures formed in generally opposed ends, it is noted that member 111 may have more than two apertures, or may have a single aperture, such as shown in FIG. 1A.

In one embodiment, one or more of the apertures formed in generally opposed ends 112 is sized to receive an identical, or substantially similar, member there through such that a chain link having a geometry identical, or substantially similar, to chain link 110 may be displaced through aperture 130. It is noted, however, that the present technology is not limited to an aperture of any particular size or shape.

In one embodiment, member 111 may optionally have one or more perforations 150 other than the aforementioned apertures formed therein. Consider the example where chain link 110 constitutes a link in a chain, wherein a second chain link is disposed behind chain link 110. First major surface 114 of member 111 is a first color, and a visible surface of the second chain link is a second, different color. The two links are respectively positioned such that the visible surface of the second chain link may be seen through one or more perforations 150 of member 111 such that the second color shows through one or more perforations 150 and is visibly contrasted by the first color of first major surface 114.

In this manner, an example provides that configuring member 111 so as to include one or more perforations 150 may be implemented so as to add to the overall aesthetic attractiveness of the resulting chain. Moreover, in so much as member 111 may be made of, or plated with, a relatively costly material, such as a precious metal, forming one or more perforations 150 in member may have the practical effect of minimizing the cost of manufacturing chain link 110.

The foregoing notwithstanding, it is noted that a correlation exists between the aesthetic appearance of a chain constructed from a number of link components and the physical dimensions of such components. For example, increasing the surface area of a light reflective surface of chain link 110 has the practical effect of increasing the amount of light that may be reflected by chain link 110. Moreover, in so much as a greater number of facets may be included in a larger surface, increasing the surface area of chain link 110 can also cause the amount of “sparkling” associated with chain link 110 to be increased. It is noted, however, that more material (e.g., gold) will be used to create a larger surface area, which causes the cost of manufacturing chain link 110 to increase. Therefore, a cost-benefit relationship exists between the manufacturing costs and aesthetic attractiveness of the end product.

In addition to the foregoing, an embodiment provides that selecting a particular shape of the links of a chain will make the chain look different, such as by providing the chain with specific physical dimensions that are a function of the shape of the implemented link components. For purposes of illustration, the following exemplary geometries of chain link 110 will now be explored.

With reference now to FIG. 1C, a third exemplary configuration 102 of chain link 110 in accordance with an embodiment disclosed herein is shown. Member 111 of chain link 110 is shown as being generally “C” shaped. However, as stated above, the present technology is not limited to any specific geometry of a chain link.

Pursuant to one exemplary embodiment, member 111, as shown in FIG. 1C, has a length 160 of 3.75 millimeters (mm) and a base width 162 of 1 mm. Member 111 also has an inlet length 161 of 2.75 mm and a gap width 165 of 0.4 mm. Additionally, an aperture 130 is formed in chain link 110, wherein aperture 130 has a major diameter 163 of 1.6 mm and a minor diameter 164 of 0.5 mm. It is noted, however, that these specific dimensions are exemplary, and that the present technology is not limited to these exemplary dimensions.

With reference still to FIG. 1C, member 111 has an inner edge 116 and an outer edge 117, wherein inner edge 116 is located adjacent to inlet 140, and wherein outer edge 117 is positioned away from inlet 140. It is noted that inner and outer edges 116, 117 may constitute different portions of a peripheral surface of member 111. In one embodiment, one or more of generally opposed ends 112 has a major width 166 between a point of inner edge 116 and a point of outer edge 117, wherein major width 166 is substantially normal to inner edge 116 and outer edge 117 at the aforementioned points. Moreover, major diameter 163 is at least as long as major width 166 such that another member having an identical geometry to member 111 may be inserted through aperture 130.

It is noted, however, that other geometries may also be implemented pursuant to the present technology. With reference now to FIG. 1D, a fourth exemplary configuration 103 of chain link 110 in accordance with an embodiment disclosed herein is shown. Member 111 of chain link 110 is shown as being generally “C” shaped. However, as stated above, the present technology is not limited to any specific geometry of a chain link.

Pursuant to one exemplary embodiment, member 111, as shown in FIG. 1D, has a length 160 of 3.75 mm and a width 168 of 3.75 mm. Member 111 also has a base width 162 of 0.9 mm, an inlet length 161 of 2.85 mm and a gap width 165 of 0.77 mm. Additionally, an aperture 130 is formed in member 111, wherein aperture 130 has a major diameter 163 of 1.1 mm and a minor diameter 164 of 0.35 mm. Moreover, a closest distance 167 between aperture 130 and an inner edge 116 of member 111 is 0.25 mm. It is noted, however, that these specific dimensions are exemplary, and that the present technology is not limited to these exemplary dimensions.

In addition to the foregoing, other geometries may also be implemented pursuant to the present technology. With reference now to FIG. 1E, a fifth exemplary configuration 104 of chain link 110 in accordance with an embodiment disclosed herein is shown. Member 111 of chain link 110 is shown as being generally “V” shaped. However, as stated above, the present technology is not limited to any specific geometry of a chain link.

Pursuant to one exemplary embodiment, member 111, as shown in FIG. 1E, has a length 160 of 4.8 mm. Member 111 also has a base width 162 of 1.3 mm, an inlet length 161 of 3.5 mm and a gap width 165 of 0.7 mm. Additionally, an aperture 130 is formed in member 111, wherein aperture 130 has a major diameter 163 of 1.7 mm and a minor diameter 164 of 0.7 mm. It is noted, however, that these specific dimensions are exemplary, and that the present technology is not limited to these exemplary dimensions.

With reference now to FIG. 1F, a sixth exemplary configuration 105 of chain link 110 in accordance with an embodiment disclosed herein is shown. Member 111, as shown in FIG. 1F, has a length 160 of 6.6 mm and a width 168 of 3.75 mm. Member 111 also has a base width 162 of 3 mm and a gap width 165 of 0.5 mm. Additionally, a number of apertures 131 are formed in member 111, wherein apertures 131 each have a major diameter 163 of 4 mm and a minor diameter 164 of 0.73 mm, wherein one or more closest distances 169 between one or more of apertures 131 and inner edge 116 or outer edge 117 of member 111 is 0.45 mm. It is noted, however, that these specific dimensions are exemplary, and that the present technology is not limited to these exemplary dimensions.

It is noted that FIG. 1F shows an embodiment wherein inlet 140 of member 111 does not pass apertures 131, which is different than various other embodiments described herein. This configuration provides a greater respective surface area for base member 113, although more material (e.g., gold) is included in this area. However, in so much as a correlation exists between the amount of visible surface area and the amount of light that may be reflected and/or the amount of “sparkling” that may be achieved, such as where base member 113 of member 111 includes a number of facets, having a larger base member may increase the aesthetic appeal of a chain that includes chain link 110.

With reference now to FIG. 1G, a seventh exemplary configuration 106 of chain link 110 in accordance with an embodiment disclosed herein is shown. Member 111, as shown in FIG. 1F, has a length 160 of 3.75 mm and a width 168 of 3.75 mm. Member 111 also has a base width 162 of 0.8 mm, an inlet length 161 of 2.95 mm and a gap width 165 of 0.4 mm. Additionally, an aperture 130 is formed in member 111, wherein aperture 130 has a major diameter 163 of 1.6 mm and a minor diameter 164 of 0.5 mm. It is noted, however, that these specific dimensions are exemplary, and that the present technology is not limited to these exemplary dimensions.

With reference still to FIG. 1G, member 111 has a first major surface 114 and a second major surface (not shown) located generally opposite to first major surface 114 on a reverse side of member 111. Member 111 also has a side or peripheral surface 115 that corresponds to or defines an outer edge of member 111, wherein peripheral surface is located adjacent to both first major surface 114 and the aforementioned second major surface. In an embodiment, a number of indentations 118 are formed in peripheral surface 115, such as adjacent to base member 113. Indentations 118 may be provided, for example, to reduce an amount of material used to fabricate member 111, while simultaneously maintaining a particular structural strength based on a number of ridges 119 that exist between indentations 118.

In view of the foregoing, FIGS. 1A-1G depict a physical geometry or outline of a basic link component, which may be implemented in a chain such as described herein. However, the present technology is not limited to the specific geometries or outlines shown in FIGS. 1A-1G. Rather, the present technology includes obvious variants of the embodiments disclosed herein.

### Exemplary Linking Arrangements

Various exemplary linking arrangements in accordance with the present technology will now be described. However, the present technology is not limited to these exemplary linking arrangements. Indeed, other linking arrangements may also be implemented pursuant to the present technology.

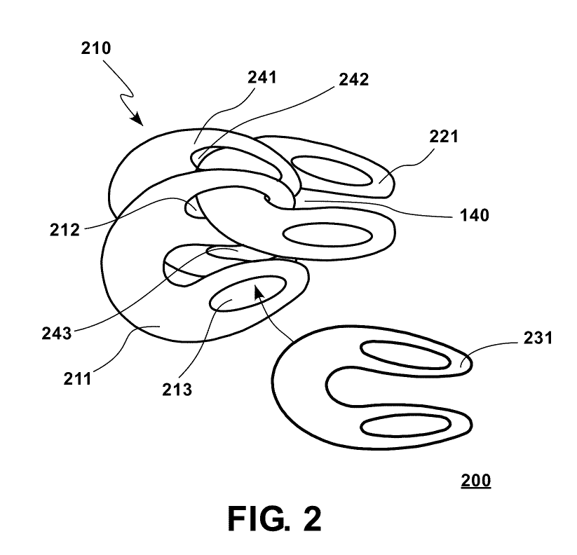

With reference now to FIG. 2, a first exemplary linking configuration 200 in accordance with an embodiment disclosed herein is shown. In particular, a chain 210 includes a first chain link 211, such as chain link 110 described above, wherein first chain link 211 may be planar and/or generally “U” or “V” shaped, and wherein a first aperture 212 is formed in first chain link 211. Chain 210 also includes a second chain link 221 positioned through first aperture 212.

In one embodiment, a second aperture 213 is formed in first chain link 211, and a third chain link 231 is positioned through second aperture 213. Moreover, an embodiment provides that chain 210 further includes a fourth chain link 241 with a third aperture 242 and a fourth aperture 243 formed therein, wherein second chain link 221 is positioned through both first aperture 212 of first chain link 211 and third aperture 242 of fourth chain link 241, and wherein third chain link 231 is positioned through second aperture 213 of first chain link 211 and fourth aperture 243 of fourth chain link 241.

Thus, FIG. 2 shows the interlinking of a link component with an adjacent pair of link components so as to form a chain segment. Furthermore, one or more of the various chain links shown in FIG. 2 may be planar and/or generally “U” or “V” shaped, and two or more of such chain links may have a geometry that is substantially similar or identical.

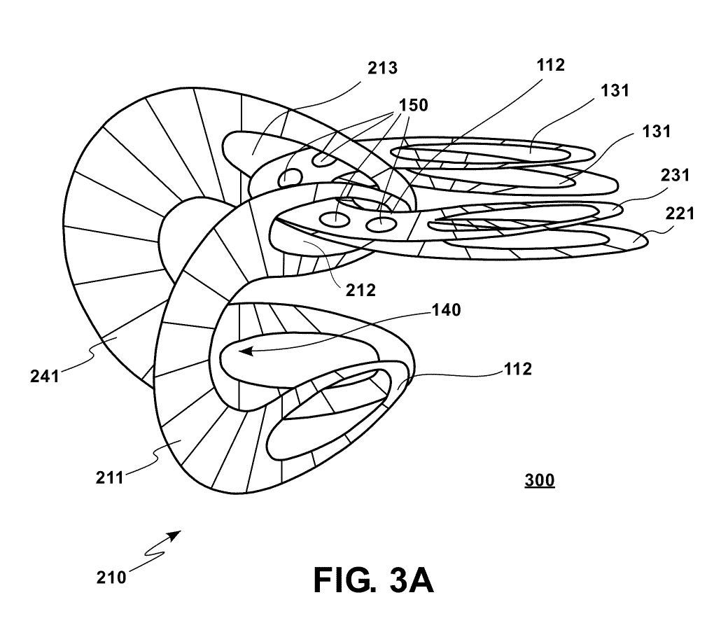

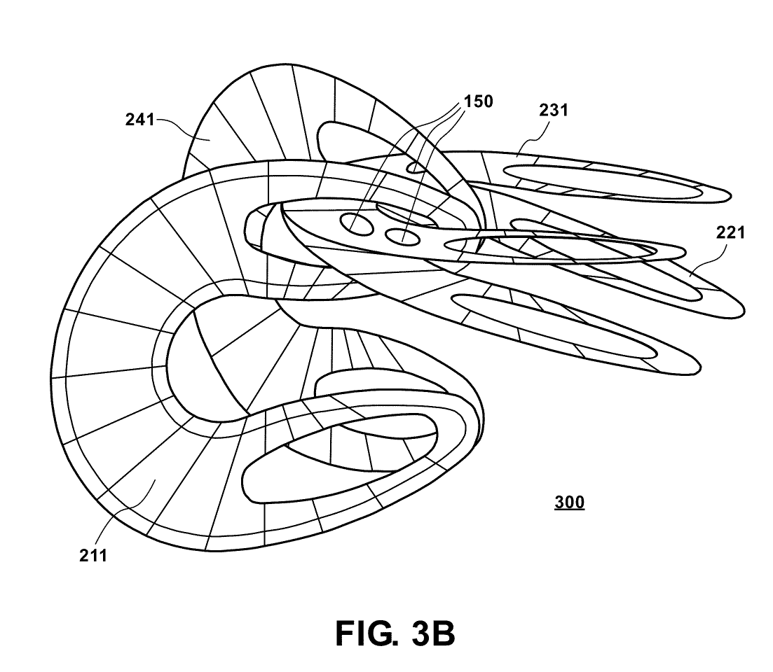

With reference now to FIGS. 3A and 3B, different views of a second exemplary linking configuration 300 in accordance with an embodiment disclosed herein are shown. Similar to the embodiment illustrated in FIG. 2, FIGS. 3A and 3B illustrate a chain 210 that includes a first chain link 211, such as chain link 110 described above, wherein a first aperture 212 is formed in first chain link 211, and wherein a second chain link 221 is positioned through first aperture 212. Additionally, however, a third chain link 231 is positioned through first aperture 212. Thus, in contrast to a single link component being positioned through first aperture 212 of first chain link 211 (see, e.g., second chain link 221 shown in FIG. 2), an embodiment provides that two or more links (e.g., second and third chain links 221, 231 arranged in a stacked or side-by-side configuration) may be positioned through first aperture 212 of first chain link 211.

In one embodiment, chain 210 also includes a fourth chain link 241 with a second aperture 213 formed therein, wherein second and third chain links 221, 231 are both positioned through first aperture 212 of first chain link 211 as well as through second aperture 213 of fourth chain link 241. Therefore, an embodiment provides for continuous chain pairs or groupings that are linked together in chain 210, such as shown in FIGS. 3A and 3B. Furthermore, one or more of the aforementioned chain links may have a physical geometry such as described herein. In particular, one or more of such chain links may be planar and/or generally “U” or “V” shaped, such as described above.

Thus, an embodiment provides a linking configuration for similarly shaped link components, wherein two or more links are substituted for a single link, such as described above, and wherein such configuration may be implemented to minimize production costs, such as by increasing precious metal savings, as well as to provide decorative qualities. Consider the example where second and third chain links 221, 231 are grouped in a side-by-side configuration, such as shown in FIGS. 3A and 3B, wherein third chain link 231 is made of gold and second chain link 221 is made of silver. Third chain link 231 is disposed in an outwardly facing position so that it can be maximally exposed to a viewer. While apertures 131 formed in second and third chain links 221, 231 are configured to be congruent in size and dimensions, so as to be adapted for further similarly or identically sized members to be inserted there through, third chain link 231 is dimensionally smaller than second chain link 221. The result is a decorative effect whereby third chain link 231, which is made of gold, is framed by second chain link 221, which is made of silver, with peripheral portions of second chain link 221 extending beyond the edge of third chain link 231.

In view of the foregoing, and in so much as second and third chain links 221, 231 have substantially similar geometries, second and third chain links 221, 231 appear as a single link with a gold inner portion surrounded by a silver fringe when second and third chain links 221, 231 abut one another. Pursuant to one embodiment, however, second and third chain links 221, 231 are not adhered together, yet the aforementioned aesthetic effect is nevertheless achieved because second and third chain links 221, 231 are held in close proximity to one another when positioned through first aperture 212 and/or second aperture 213.

In one example, third chain link 231, which is made of gold, may be manufactured so as to be relatively thin, but complemented with second chain link 221, which is made of silver, wherein the result is a relatively heavier combination link that gives the total piece weight and substance of second chain link 221 as shown in FIG. 2. At the same time, the combined link component, which includes second and third chain links 221, 231, gives the impression of a single link component, without having to undergo a process to bond gold with silver, consisting of a central gold core with an outlying silver fringe.

Thus, and with reference still to FIGS. 3A and 3B, an embodiment provides that first chain link 211 has generally opposed ends 112 with an inlet 140 formed there between, wherein second chain link 221 and third chain link 231 are respectively positioned closer to and farther from inlet 140, and wherein second chain link 221 is dimensionally larger than third chain link 231. It is noted that such a configuration, in addition to its decorative attributes, may be implemented to achieve a substantial savings in cost. For example, the use of such paired link components, which may be referred to as multi-links, allows for savings on the use of various materials, such as precious metals (e.g., gold), while permitting the introduction of new design possibilities.

It is further noted, however, that the aforementioned arrangement is an example of one of many possible combinations. For example, chain 210 may include three or more grouped link components wherein different color chain links are arranged in a stacked or side-by-side configuration so as to increase the aesthetic attractiveness of chain 210. To illustrate, consider the example where second and third chain links 221, 231, are made of silver and gold, respectively, and are sized as described above. Additionally, another, larger link component made of, for example, black metal, is grouped with second and third chain links 221, 231 such that the three chain links are each positioned through first aperture 212 of first chain link 211 in a side-by-side configuration, wherein second chain link 221 is positioned between third chain link 231 and the black chain link. In so much as the black link component is dimensionally larger than second chain link 221, the result of the three links is a combination link in three tones: a gold core, a black outer fringe and a silver lining between the black outer fringe and the gold core.

The foregoing notwithstanding, in one embodiment, instead of pairing two or more similarly-shaped link components together, two or more link components may be used with varying configurations, dimensions and/or colors to achieve differing decorative effects. To illustrate, and in accordance with an embodiment, a surface of third chain link 231 is perforated such that one or more perforations 150 formed therein have the practical effect of increasing a viewability of second chain link 221, such as to further increase an aesthetic attractiveness of chain 210, such as where second chain link 221 is a different color than third chain link 231. Consider the example where second and third chain links 221, 231 are made of silver and gold, respectively, as described above. While maintaining the congruence of the respective eyelets or apertures of the two paired link components, the smaller gold paired link component (third chain link 231) may be perforated with openings that expose the surface of the larger silver paired link component (second chain link 221), thus giving the combined link component a leopard-spotted decorative appearance.

It is noted, however, that the present technology is not limited to the color combinations and physical arrangements discussed herein. Indeed, many other decorative variations may also be achieved in accordance with the present technology.

### Exemplary Chain Arrangements

Various exemplary chain arrangements in accordance with the present technology will now be described. However, the present technology is not limited to these exemplary chain arrangements. Indeed, other chain arrangements may also be implemented pursuant to the present technology.

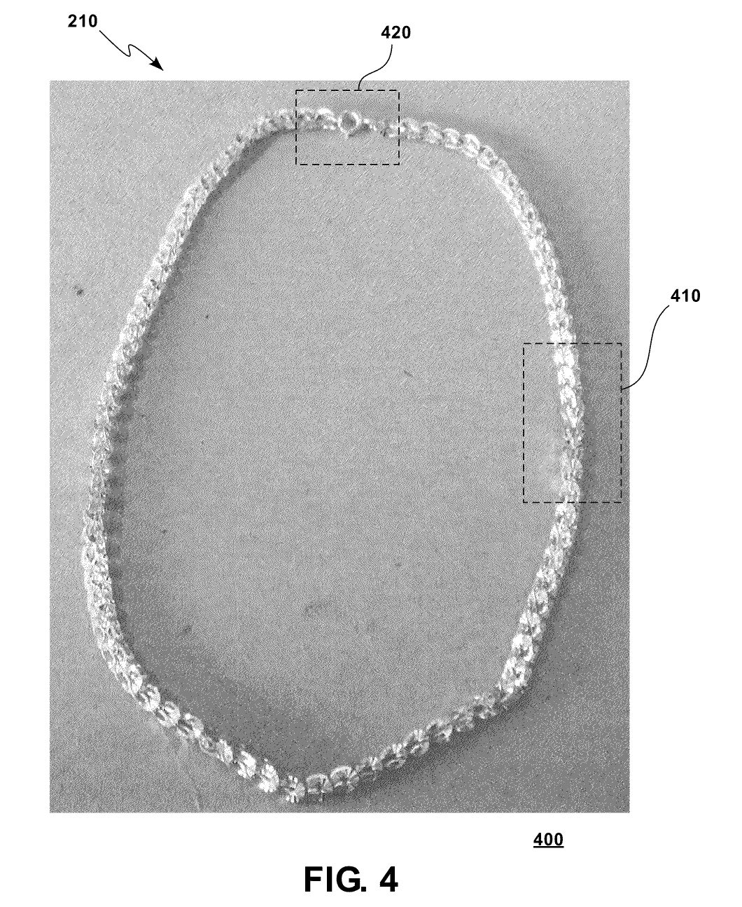

With reference now to FIG. 4, a chain 210 in accordance with an embodiment disclosed herein is shown. Chain 210 includes multiple link components, such as exemplary chain links 410, wherein one or more of these chain links have a geometry substantially as described above with regard to chain link 110, and wherein the various chain links are linked together in a manner such as described above. Moreover, in one embodiment, chain 210 also includes a coupling member 420, such as further described herein, wherein coupling member 420 is configured to couple or attach opposite ends of chain 210. In this manner, it is noted that chain 210 may be sized so as to function as a necklace, bracelet, or some other piece of jewelry.

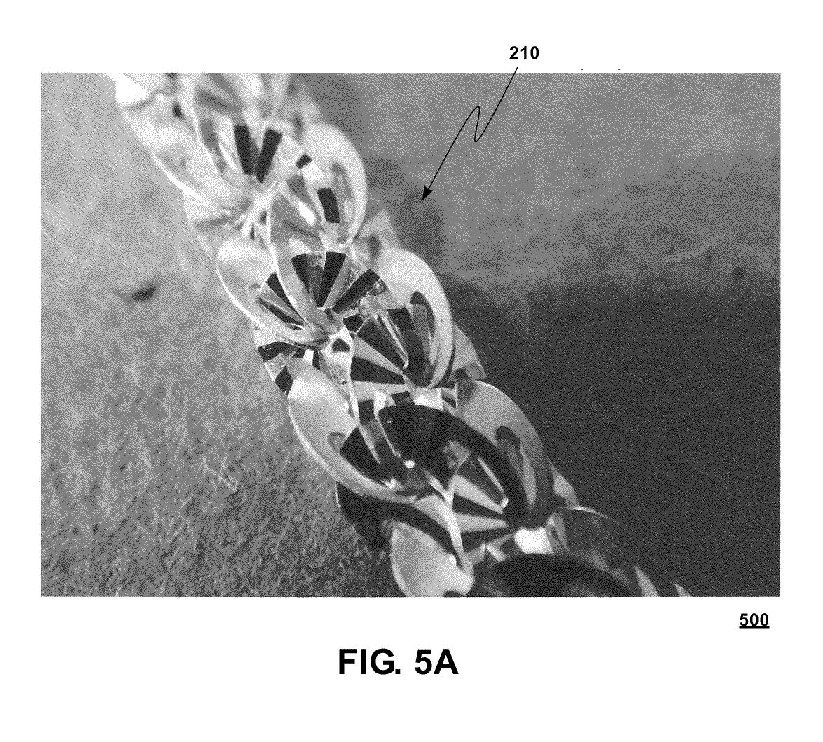

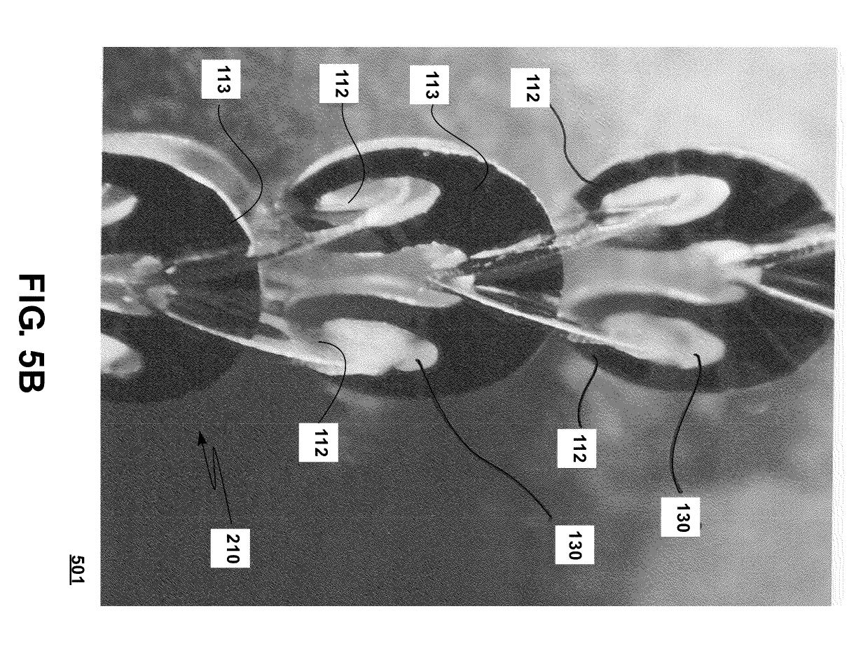

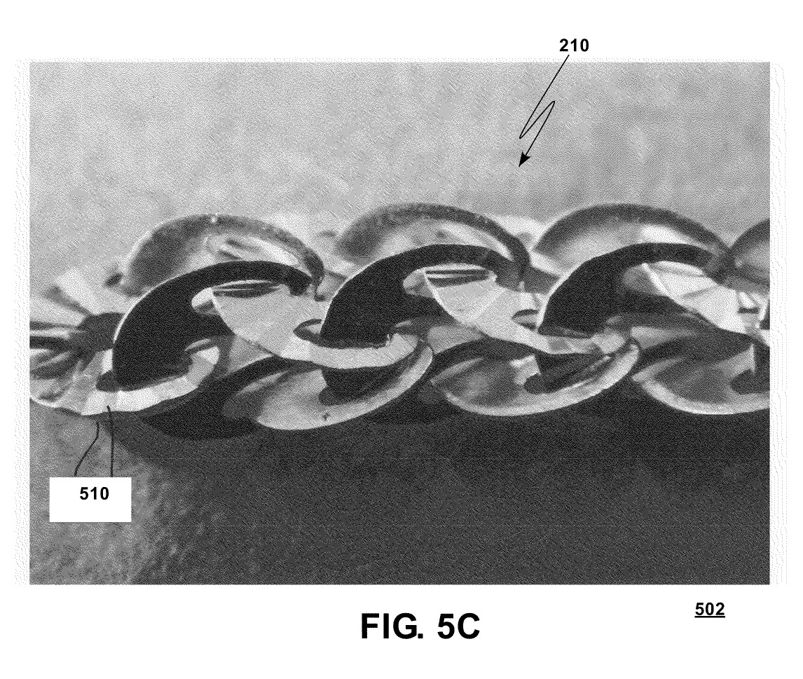

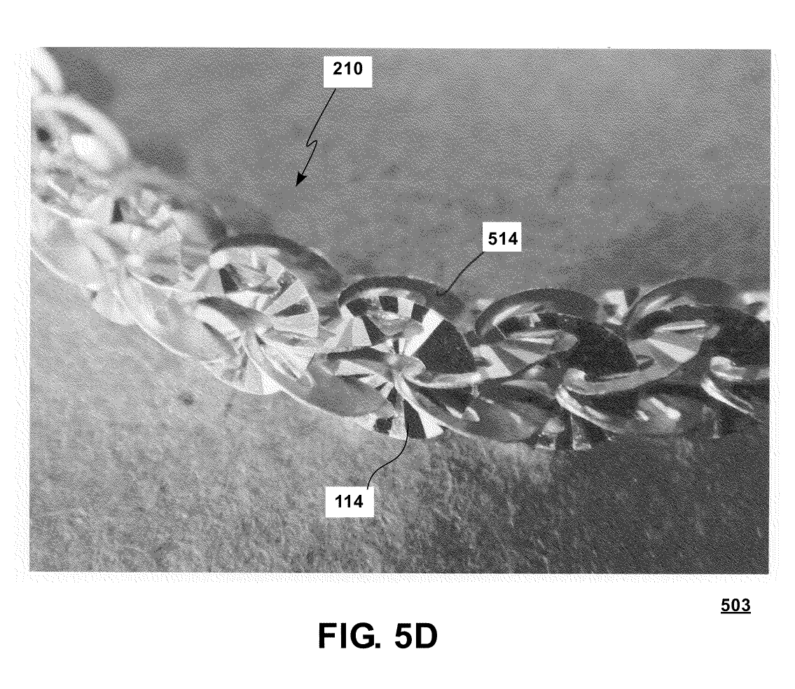

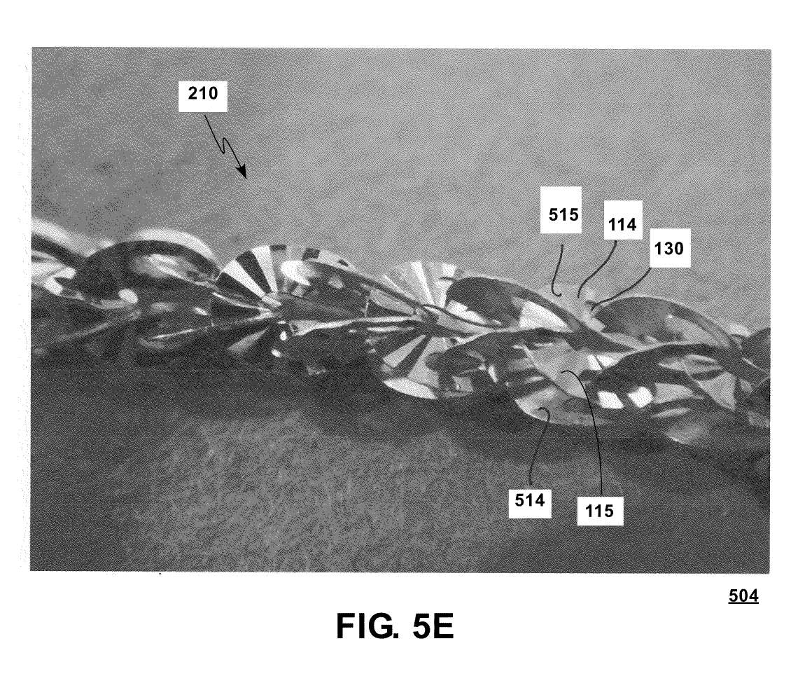

With reference now to FIGS. 5A-5E, different views 500-504 of a plurality of linked elements of chain 210, such as exemplary chain links 410, in accordance with an embodiment disclosed herein are shown. In each of these figures, the linked components constitute a chain segment corresponding to a portion of chain 210. The basic link component of chain 210 may be an essentially “U” or “V” shaped disk, such as previously described herein, which includes a connecting stem or base member 113 with generally opposed ends 112, or appendages, at each end of base member 113. The two generally opposed ends 112 are spaced apart by a gap 141, and an inlet 140 is formed between the two generally opposed ends 112 of each link component and the interior facing portion of base member 113, while an eyelet, opening or aperture 130 is formed in each of the two generally opposed ends 112. Moreover, two or more link components 510 may be positioned in a stacked configuration, such as previously described herein.

With reference still to FIGS. 5A-5E, one or more of the link components of chain 210 have a first major surface 114 and a second major surface 514 located opposite first major surface 114. It is noted that first major surface 114 may refer to the side that faces to the exterior of the link component, and second major surface 514 may refer to the side that faces internally toward the axis of the chain 210. Additionally, the link component has a peripheral surface 115 on the edge of the link component, such as described above.

The foregoing notwithstanding, an embodiment provides that one or both of first and second major surfaces 114, 514 are rounded or contain surface variations from one part of the major surface to another rather than being substantially flat. Indeed, in an embodiment, one or more of the surfaces of the various link components may have a number of facets 515 formed therein so as to cause such surfaces to reflect light in different directions with respect to a light source.

Consider the example where first major surface 114 has undergone a process of “diamond-cutting” in which a plurality of facets 515, which may be “V” shaped, have been carved onto first major surface 114. Facets 515 provide the link component, as well as resulting chain 210, with numerous reflective surfaces that reflect light at various angles. In one embodiment, both first major surface 114 and second major surface 514 may be “diamond-cut” with a plurality of facets 515. Indeed, in accordance with one example, a chain having link components with both of their respective major surfaces (first and second major surfaces 114, 514) rendered with diamond-cut facets will appear to be more light reflective than a similar chain having link components each with a single faceted surface.

In one embodiment, however, instead of having a diamond-cut faceted surface, the first and second major surfaces 114, 514 are fashioned or fabricated so as to be substantially flat with polished surfaces. A chain produced by link components with flat polished surfaces will still glisten with reflected light because of the surfaces of many different link components on the chain, which are respectively located at different angles with respect to light sources in the general area.

Moreover, an embodiment provides that the shape of peripheral surface 115 may be varied. For example, numerous serrations may be formed along an edge of peripheral surface 115, such as indentations 118 shown in FIG. 1G, which would also increase the ability of chain 210 to reflect light at different directions with respect to a light source. In one example, however, peripheral surface 115, rather than having substantially angular corners, may include an expanded and/or rounded cross-section.

Thus, an embodiment provides that the basic link component of a chain as disclosed herein is a planar, generally “U” or “V” shaped chain link with one or more eyelets formed therein, wherein such eyelets are sized such that another chain link of similar or identical size may be inserted there through. With respect to other link components, it is noted that a person having ordinary skill in the art would previously not have been motivated to bend or reconfigure such chain links so as to cause them to become planar and generally “U” or “V” shaped. Indeed, and with reference still to FIGS. 5A-5E, an embodiment provides that the generally “U” or “V” shaped configuration of various exemplary link components described herein is adopted to support a novel configuration for linking such components into a chain that, although substantially hollow, enables surface area of the resulting chain to be maximized so as to reduce manufacturing costs while maintaining the aesthetic appeal of the end product.

It is noted, however, that the foregoing configurations and arrangements are presented herein for purposes of illustration, and that the present technology is not limited to these exemplary configurations and arrangements. By varying the shape of the link components, or by differing visual properties of the individual link components, the portions and locations of the link components with which the differing visual properties are associated, or the sequence and position of the link components with different visual properties within the chain itself, countless design combinations may be achieved in accordance with the present technology.

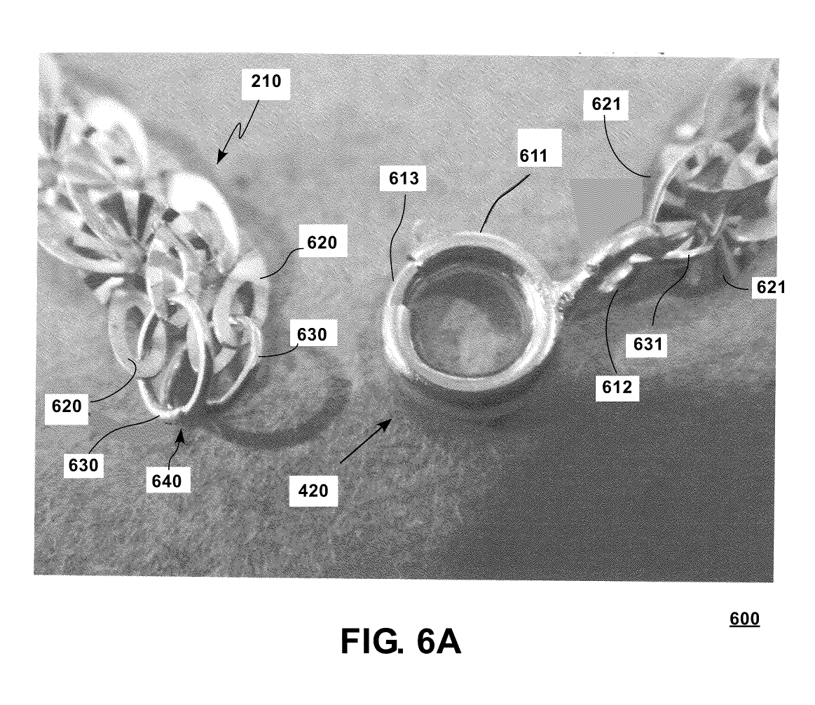

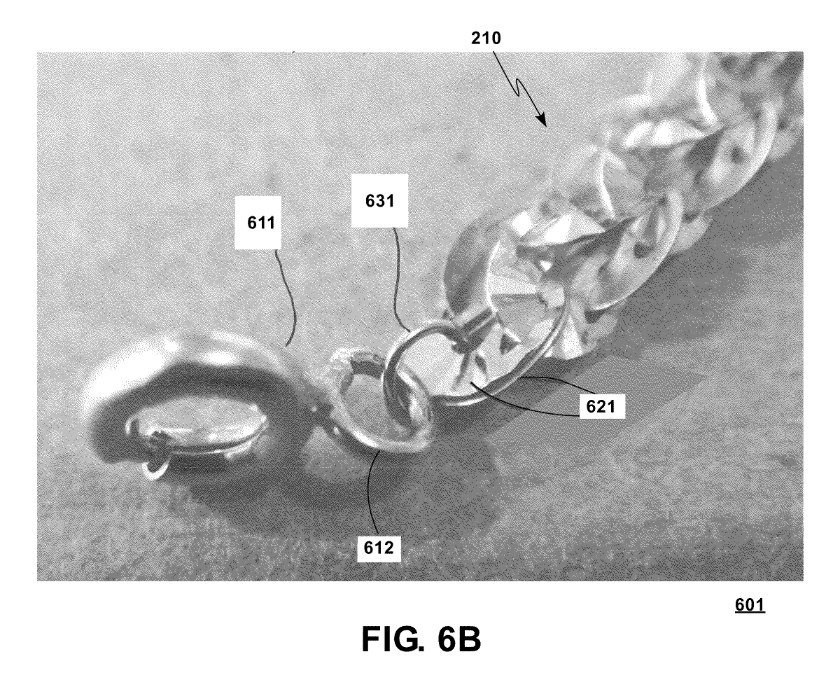

With reference now to FIGS. 6A-6B, different views 600, 601 of a coupling member 420 of chain 210 in accordance with an embodiment disclosed herein are shown. With specific reference to FIG. 6A, opposite ends of a chain made from a plurality of link components, such as those link components described herein, are shown, wherein these opposite ends include first and second connecting elements, respectively.

As shown in FIGS. 6A-6B, chain 210 includes one or more link components 620 positioned through, or linked with, one or more annular links 630. In one embodiment, chain 210 includes multiple annular links that are attached or soldered together at a common point 640. However, although such annular links are attached or soldered together, an exemplary configuration provides that the other individual link components that form chain 210, such as the planar and generally “U” or “V” shaped link components discussed herein, are not soldered together, which both simplifies and speeds the manufacturing process.

With reference still to FIGS. 6A-6B, chain 210 further includes another annular link 631, wherein one or more other link components, such as link components 621, are positioned through, or linked with, annular link 631. Coupling member 420 includes a clasp 611 and an annular stem 612 extending from clasp 611, wherein annular stem 612 is positioned through, or linked with, annular link 631. A mouth 613 of clasp 611 is configured to open such that clasp 611 may be positioned through or linked with one or more annular links 630.

It is noted, however, that the present technology is not limited to the aforementioned connecting elements. Indeed, other means for connecting opposite ends of chain 210 may also be implemented in accordance with the present technology.

### Exemplary Methods of Manufacture

Various exemplary methods of chain manufacture in accordance with the present technology will now be described. However, the present technology is not limited to these exemplary methods. Indeed, other methods of chain manufacture may also be implemented pursuant to the present technology.

In an embodiment, the manufacturing of the individual link components disclosed herein may be accomplished using a suitable method of stamping the individual link component from a sheet of material. In this regard, a process of diamond cutting, such as to provide the individual links with a number of surface facets, such as described above, may be applied to a sheet of material prior to the stamping of the individual link components from such material. In one embodiment, however, the individual links may be stamped from a piece of material and subsequently undergo the diamond cutting process.

The foregoing notwithstanding, in an embodiment, a process of “laser-cutting” is implemented such that laser cuts are applied to the surface of a material providing a reflective surface. Laser cutting can be used to replace or enhance stamping and diamond-cutting because of its ability to mass produce jewelry items with increased precision. Moreover, laser-cutting can be used to shape and cut metal, including precious metals, into very thin pieces.

Consider the example where a process of laser-cutting is used to form a relatively thin piece of gold jewelry. This gold portion is then coupled to another piece of jewelry made of silver, which is less expensive than gold. The resulting piece of jewelry has a greater overall weight, while production costs may be minimized. Indeed, such a method of manufacture may lead to relatively substantial financial savings during the fabrication process.

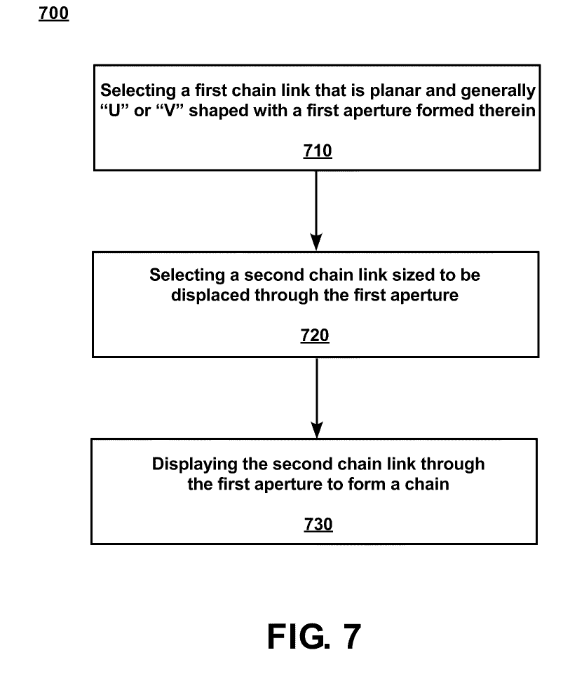

With reference now to FIG. 7, an exemplary method 700 of chain manufacture in accordance with an embodiment disclosed herein is shown. Method 700 includes selecting a first chain link that is planar and generally “U” or “V” shaped with a first aperture formed therein 710, selecting a second chain link sized to be displaced through the first aperture 720, and displacing the second chain link through the first aperture to form a chain 730. It is noted that method 700 may be performed, for example, after the individual link components have been manufactured such as described above.

It is noted that the visual appearance of the chain produced by the link components described herein, such as by implementing one of the methods of interlinking such components discussed herein, may be varied by applying different visual properties to the link components. A visual property may be defined as a characteristic of an object which presents a particular visual image to the eye. Such characteristics include, but are not limited to, color, texture, pattern, material, physical shape or luster. Not only does the visual property of each link component contribute to the visual appearance of the chain that is produced, but the particular sequence of link components of varying visual properties can affect the visual appearance of the chain. For example, a chain in accordance with the present technology could display a repeated pattern for the entire length of the chain, or the repeated pattern may continue for only a portion of the chain with a different pattern for another part of that same chain.

In one embodiment, method 700 further includes selecting the first chain link, wherein the first aperture has a diameter and the first chain link has inner and outer peripheral edges and a major width that is substantially normal to the inner and outer peripheral edges, and selecting the diameter such that the diameter is at least as long as the major width. In this manner, method 700 may include selecting an aperture diameter such that an identically sized chain link may be displaced through such aperture, as described above.

Method 700 may also be expanded so as to add a number of additional chain links to the manufactured chain. In an embodiment, method 700 includes selecting the first chain link, wherein a second aperture is formed in the first chain link, selecting a third chain link sized to be displaced through the second aperture, and displacing the third chain link through the second aperture. Method 700 may also include selecting a fourth chain link with third and fourth apertures formed therein, selecting the second chain link, wherein the second chain link is sized to be displaced through the third aperture, selecting the third chain link, wherein the third chain link is sized to be displaced through the fourth aperture, displacing the second chain link through the third aperture, and displacing the third chain link through the fourth aperture. Indeed, method 700 may further include selecting a fifth chain link sized to be displaced through the first and third apertures, selecting a sixth chain link sized to be displaced through the second and fourth apertures, displacing the fifth chain link through the first and third apertures, and displacing the sixth chain link through the second and fourth apertures.

In view of the foregoing, it is noted that method 700 may be implemented so as to interlink a number of chain link pairs. The number of chain link pairs that are interlinked will determine the length of the resulting chain. Indeed, additional chain link pairs may also be added to the chain, such as in the manner described above, so as to make the chain longer. For example, method 700 may be further expanded so as to include the displacement of a number of additional chain links through apertures formed in the third, fifth and/or sixth chain links of the manufactured chain.

To further illustrate, and with reference again to FIG. 6B, an exemplary method of constructing chain 210 involves link components 621 being placed adjacent to each other with the respective inner major surfaces of link components 621 facing each other and the respective outer major surfaces of link components 621 facing way from each other. It is noted, however, that a single link component may be used to initiate the making of chain 210 instead of using two of these components. Additionally, link components 621 are threaded through annular link 631 such that their respective inlets abut against a portion of annular link 631. Furthermore, annular link 631 is linked with clasp 611, by means of annular stem 612, wherein clasp 611 is configured to be connected, during use, to the other end of chain 210.

At this point, a chain segment has been formed with link components 621 disposed at an end of the chain segment. Next, additional pairs of link components are linked with link components 621. Consider the example where link components 621 are first and fourth chain links 211, 241 shown in FIG. 2. Second chain link 221 is threaded through corresponding and opposing eyelets or apertures 212, 242 of first and fourth chain links 211, 241, so that inlet 140 of second chain link 221 abuts against the portion of apertures 212, 242 located nearest the extremity of its corresponding appendage. Furthermore, third chain link 231 is similarly threaded through a number of other apertures 213, 243 of first and fourth chain links 211, 241. The appendages of second and third chain links 221, 231 are brought together in close proximity, and this process is repeated with successive pairs of link components until a particular length of chain 210 is achieved.

When such length of chain is achieved, annular links 630 are threaded through each pair of corresponding eyelets as shown in FIG. 6A. Annular links 630 are then soldered together at common point 640 to prevent unraveling of chain 210, such as to make it easier for clasp 611 to connect to annular links 630. It is noted, however, that other coupling means may be used in place of clasp 611 and annular links 630 so as to connect the two ends of chain 210.

### Summary Concepts

It is noted that the foregoing discussion has presented at least the following concepts:

Concept 1. A planar, generally “U” or “V” shaped chain link, including or comprising:

a member with at least one aperture formed therein, the at least one aperture sized to receive an identical member there through.

Concept 2. The chain link of Concept 1, wherein the member is substantially “C” shaped.
Concept 3. The chain link of Concept 1, wherein the member has major surface and a peripheral surfaces located adjacent to the major surface, the peripheral surface defining an outer edge of the member.
Concept 4. The chain link of Concept 3, wherein the peripheral surface is a light reflective surface having a number of protrusions formed therein.
Concept 5. The chain link of Concept 4, wherein the protrusions are “V”-shaped facets.
Concept 6. The chain link of Concept 3, wherein a number of indentations are formed in the peripheral surface.
Concept 7. The chain link of Concept 1, wherein the member has one or more perforations other than the at least one aperture.
Concept 8. The chain link of Concept 1, wherein the member has generally opposed ends each having an aperture formed therein, the aperture sized to receive an identical member there through.
Concept 9. The chain link of Concept 8, wherein the at least one aperture has a major diameter and the member has an inner edge, an outer edge and generally opposed ends, an inlet being formed between the generally opposed ends, the inner edge being adjacent to the inlet, and the outer edge being positioned away from the inlet, and wherein at least one of the generally opposed ends has a major width between a point of the inner edge and a point of the outer edge, the major width being substantially normal to the inner and outer edges at the points, and the major diameter being at least as long as the major width.
Concept 10. A chain including or comprising:

a first chain link being planar and generally “U” or “V” shaped with a first aperture formed therein; and

a second chain link positioned through the first aperture.

Concept 11. The chain of Concept 10, wherein a second aperture is formed in the first chain link, the chain further including or comprising:

a third chain link positioned through the second aperture.

Concept 12. The chain of Concept 11, further including or comprising:

a fourth chain link with third and fourth apertures formed therein, the second and third chain links being respectively positioned through the third and fourth apertures.

Concept 13. The chain of Concept 12, wherein one or more of the second, third and fourth chain links are planar and/or generally “U” or “V” shaped.
Concept 14. The chain of Concept 10, further including or comprising:

a third chain link positioned through the first aperture.

Concept 15. The chain of Concept 14, wherein the first chain link has generally opposed ends with an inlet formed there between, the second and third chain links being respectively positioned closer to and farther from the inlet, and the second linking member being dimensionally larger than the third linking member.
Concept 16. The chain of Concept 14, wherein the second and third chain links are different colors.
Concept 17. The chain of Concept 16, wherein a surface of the third chain link is perforated.
Concept 18. The chain of Concept 14, wherein a second aperture is formed in the first chain link, the chain further including or comprising:

a fourth chain link with third and fourth apertures formed therein, the second and third chain links being positioned through third aperture; and

fifth and sixth chain links positioned through the second and fourth apertures.

Concept 19. The chain of Concept 10, further including or comprising:

an annular link, the first chain link being positioned through the annular link.

Concept 20. The chain of Concept 19, further including or comprising:

a coupling member including a clasp and an annular stem extending from the clasp, the annular stem positioned through the annular link.

Concept 21. A method of chain manufacture including or comprising:

selecting a first chain link that is planar and generally “U” or “V” shaped with a first aperture formed therein;

selecting a second chain link sized to be displaced through the first aperture; and

displacing the second chain link through the first aperture to form a chain.

Concept 22. The method of Concept 21, further including or comprising:

selecting the first chain link, the first aperture having a diameter and the first chain link having inner and outer peripheral edges and a major width that is substantially normal to the inner and outer peripheral edges; and

selecting the diameter such that the diameter is at least as long as the major width.

Concept 23. The method of Concept 21, further including or comprising:

selecting the first chain link, wherein a second aperture is formed in the first chain link;

selecting a third chain link sized to be displaced through the second aperture; and

displacing the third chain link through the second aperture.

Concept 24. The method of Concept 23, further including or comprising:

selecting a fourth chain link with third and fourth apertures formed therein;

selecting the second chain link, wherein the second chain link is sized to be displaced through the third aperture;

selecting the third chain link, wherein the third chain link is sized to be displaced through the fourth aperture;

displacing the second chain link through the third aperture; and

displacing the third chain link through the fourth aperture.

Concept 25. The method of Concept 24, further including or comprising:

selecting a fifth chain link sized to be displaced through the first and third apertures;

selecting a sixth chain link sized to be displaced through the second and fourth apertures;

displacing the fifth chain link through the first and third apertures; and

displacing the sixth chain link through the second and fourth apertures.

Concept 26. A method of making jewelry including or comprising the steps of:

forming generally “U” shaped and planar chain links from a material to define a base member, appendages attached to each end of the base member, an aperture formed on each the appendage, a first major surface and an opposite second major surface, an exterior edge with an inlet portion disposed on the base member between the appendages;

providing a first chain link;

providing a second chain link;

inserting an appendage of a third chain link through an aperture of the first chain link and an aperture of the second chain link so that appendages of the first chain link and second chain link are disposed on the inlet of the third chain link; and

inserting an appendage of a fourth chain link through an aperture of the first chain link and an aperture of the second chain link so that the appendages of the first chain link and second chain are disposed at the inlet of the fourth chain link.

Concept 27. A length of jewelry chain constructed of a plurality of chain links, wherein each of the chain links is generally “U” shaped and planar and is defined by a base member and appendages attached to each end of the base member, an aperture formed on each appendage, a first major surface and an opposite second major surface, an exterior edge with an inlet portion disposed on the base member between the appendages, the length of jewelry chain including or comprising:

a first chain link and a second chain link positioned so that the major surfaces of the first chain link are generally parallel to the major surfaces of the second chain link;

a third chain link with its inlet disposed with an aperture of the first chain link and an aperture of the second chain link;

a fourth chain link with its inlet disposed within an aperture of the first chain link and an aperture of the second chain link; and

the third chain link positioned so that its major surfaces are generally parallel to the major surfaces of the fourth chain link.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A planar, generally “U” or “V” shaped chain link, comprising:
a member with at least one aperture formed therein, said at least one aperture sized to receive an identical member there through.

2. The chain link of claim 1, wherein said member is substantially “C” shaped.

3. The chain link of claim 1, wherein said member has major surface and a peripheral surfaces located adjacent to said major surface, said peripheral surface defining an outer edge of said member.

4. The chain link of claim 3, wherein said peripheral surface is a light reflective surface having a number of protrusions formed therein.

5. The chain link of claim 4, wherein said protrusions are “V”-shaped facets.

6. The chain link of claim 3, wherein a number of indentations are formed in said peripheral surface.

7. The chain link of claim 1, wherein said member has one or more perforations other than said at least one aperture.

8. The chain link of claim 1, wherein said member has generally opposed ends each having an aperture formed therein, said aperture sized to receive an identical member there through.

9. The chain link of claim 8, wherein said at least one aperture has a major diameter and said member has an inner edge, an outer edge and generally opposed ends, an inlet being formed between said generally opposed ends, said inner edge being adjacent to said inlet, and said outer edge being positioned away from said inlet, and wherein at least one of said generally opposed ends has a major width between a point of said inner edge and a point of said outer edge, said major width being substantially normal to said inner and outer edges at said points, and said major diameter being at least as long as said major width.

10. A chain comprising:
a first chain link being planar and generally “U” or “V” shaped with a first aperture formed therein; and
a second chain link positioned through said first aperture.

11. The chain of claim 10, wherein a second aperture is formed in said first chain link, said chain further comprising:
a third chain link positioned through said second aperture.

12. The chain of claim 11, further comprising:
a fourth chain link with third and fourth apertures formed therein, said second and third chain links being respectively positioned through said third and fourth apertures.

13. The chain of claim 12, wherein one or more of said second, third and fourth chain links are planar and/or generally “U” or “V” shaped.

14. The chain of claim 10, further comprising:
a third chain link positioned through said first aperture.

15. The chain of claim 14, wherein said first chain link has generally opposed ends with an inlet formed there between, said second and third chain links being respectively positioned closer to and farther from said inlet, and said second linking member being dimensionally larger than said third linking member.

16. The chain of claim 14, wherein said second and third chain links are different colors.

17. The chain of claim 16, wherein a surface of said third chain link is perforated.

18. The chain of claim 14, wherein a second aperture is formed in said first chain link, said chain further comprising:
a fourth chain link with third and fourth apertures formed therein, said second and third chain links being positioned through third aperture; and
fifth and sixth chain links positioned through said second and fourth apertures.

19. The chain of claim 10, further comprising:
an annular link, said first chain link being positioned through said annular link.

20. The chain of claim 19, further comprising:
a coupling member including a clasp and an annular stem extending from said clasp, said annular stem positioned through said annular link.

21. A method of chain manufacture comprising:
selecting a first chain link that is planar and generally “U” or “V” shaped with a first aperture formed therein;
selecting a second chain link sized to be displaced through said first aperture; and
displacing said second chain link through said first aperture to form a chain.

22. The method of claim 21, further comprising:
selecting said first chain link, said first aperture having a diameter and said first chain link having inner and outer peripheral edges and a major width that is substantially normal to said inner and outer peripheral edges; and
selecting said diameter such that said diameter is at least as long as said major width.

23. The method of claim 21, further comprising:
selecting said first chain link, wherein a second aperture is formed in said first chain link;
selecting a third chain link sized to be displaced through said second aperture; and
displacing said third chain link through said second aperture.

24. The method of claim 23, further comprising:
selecting a fourth chain link with third and fourth apertures formed therein;
selecting said second chain link, wherein said second chain link is sized to be displaced through said third aperture;
selecting said third chain link, wherein said third chain link is sized to be displaced through said fourth aperture;
displacing said second chain link through said third aperture; and
displacing said third chain link through said fourth aperture.

25. The method of claim 24, further comprising:
selecting a fifth chain link sized to be displaced through said first and third apertures;
selecting a sixth chain link sized to be displaced through said second and fourth apertures;
displacing said fifth chain link through said first and third apertures; and
displacing said sixth chain link through said second and fourth apertures.
